(19) United States
(12) Patent Application Publication
(10) Pub. No.: US 2019/0108692 A1
(43) Pub. Date: Apr. 11, 2019

(54) METHOD AND APPARATUS TO ISOLATE AN ON-VEHICLE FAULT

(71) Applicant: GM Global Technology Operations LLC, Detroit, MI (US)

(72) Inventors: Xinyu Du, Oakland Township, MI (US); Mutasim A. Salman, Madison, WI (US); Yilu Zhang, Northville, MI (US); Paul E. Krajewski, Troy, MI (US)

(73) Assignee: GM Global Technology Operations LLC, Detroit, MI (US)

(21) Appl. No.: 15/728,088

(22) Filed: Oct. 9, 2017

(51) Int. Cl. G07C 5/08; G07C 5/00; B60W 50/04; B60W 50/14

(52) U.S. Cl. CPC G07C 5/0808; G07C 5/0816; G07C 5/008; B60W 2422/95; B60W 50/14; B60W 2420/54; B60W 50/04

(57) ABSTRACT

A vehicle including a monitoring system and controller for evaluating a vehicle subsystem is described. The monitoring system includes a sensor that is disposed to monitor on-vehicle noise or vibration. The subsystem includes an actuator, and a fault associated with the subsystem is defined by a fault vibration signature. A command to activate the subsystem is monitored coincident with a signal input from the sensor. A first vibration signature is determined based upon the signal input from the sensor, and a correlation between the first vibration signature and the fault vibration signature are determined for the fault associated with the subsystem. Occurrence of a fault associated with the subsystem can be detected when the correlation between the first vibration signature and the fault vibration signature associated with the subsystem is greater than a threshold correlation.

### INTRODUCTION

Vehicles may benefit from on-board monitoring systems that are configured to detect occurrence of a fault or another indication of a need for service and/or vehicle maintenance.

### SUMMARY

A vehicle is described, and includes a monitoring system and associated controller that are disposed to evaluate a vehicle subsystem. The monitoring system includes a sensor that is disposed to monitor on-vehicle noise or vibration. The subsystem includes an actuator, and a fault associated with the subsystem is defined by a fault vibration signature.

The controller is in communication with the sensor and the subsystem, and includes an instruction set that is executable to monitor a command to activate the subsystem. The controller monitors a signal input from the sensor coincident with the command to activate the subsystem. The controller determines a first vibration signature based upon the signal input from the sensor, and determines a correlation between the first vibration signature and the fault vibration signature for the fault associated with the subsystem. The controller detects occurrence of a fault associated with the subsystem when the correlation between the first vibration signature and the fault vibration signature associated with the subsystem is greater than a threshold correlation.

An aspect of the disclosure includes the actuator being a rotatable element, wherein the fault vibration signature associated with the subsystem is determined based upon a rotational speed of the rotatable element of the actuator.

Another aspect of the disclosure includes the subsystem being a wiper system and the rotatable element being a shaft of a wiper motor.

Another aspect of the disclosure includes the subsystem being a vehicle braking system and the rotatable element being a vehicle wheel.

Another aspect of the disclosure includes the subsystem being an electrical charging system and the rotatable element being a shaft of an alternator.

Another aspect of the disclosure includes the subsystem being a starting system and wherein the actuator being a shaft of a starter motor.

Another aspect of the disclosure includes the subsystem being a coolant circulation system and the actuator being a shaft of a water pump.

Another aspect of the disclosure includes the subsystem being an electric propulsion system and the actuator being a shaft of an electric motor/generator.

Another aspect of the disclosure includes the subsystem being an internal combustion engine and the actuator being a crankshaft.

Another aspect of the disclosure includes the sensor being an audio microphone having a vibration detection range associated with an audible spectrum.

Another aspect of the disclosure includes the sensor being an accelerometer.

Another aspect of the disclosure includes a telematics device being in communication with the controller and disposed to effect extra-vehicle communication, wherein the instruction set is executable to communicate the fault associated with the subsystem to an off-vehicle controller.

Another aspect of the disclosure includes a human-machine interface device being in communication with the controller, wherein the instruction set is executable to communicate the fault associated with the subsystem to a vehicle operator via the human-machine interface.

Another aspect of the disclosure includes the instruction set being executable to execute a spectrum analysis of the signal input from the vibration sensor to determine the first vibration signature.

Another aspect of the disclosure includes the instruction set being executable to isolate the detect occurrence of the fault to the subsystem.

Another aspect of the disclosure includes the instruction set being executable to intrusively command activation of the subsystem.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a vehicle including a plurality of subsystems and a vibration-based monitoring system, in accordance with the disclosure;

FIG. 2 schematically shows a process to detect and isolate a fault associated with one of the subsystems, in accordance with the disclosure; and

FIG. 3 schematically shows a frequency correlation routine to isolate a fault in one of the subsystems based upon a correlation between a subsystem fault frequency associated with a fault vibration signature and noise/vibration signals detected by a vibration-based monitoring system, in accordance with the disclosure.

It should be understood that the appended drawings are not necessarily to scale, and present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, technical material that is understood in the related art has not been described in detail in order to avoid unnecessarily obscuring the disclosure. Furthermore, the disclosure, as illustrated and described herein, may be practiced in the absence of an element that is not specifically disclosed herein.

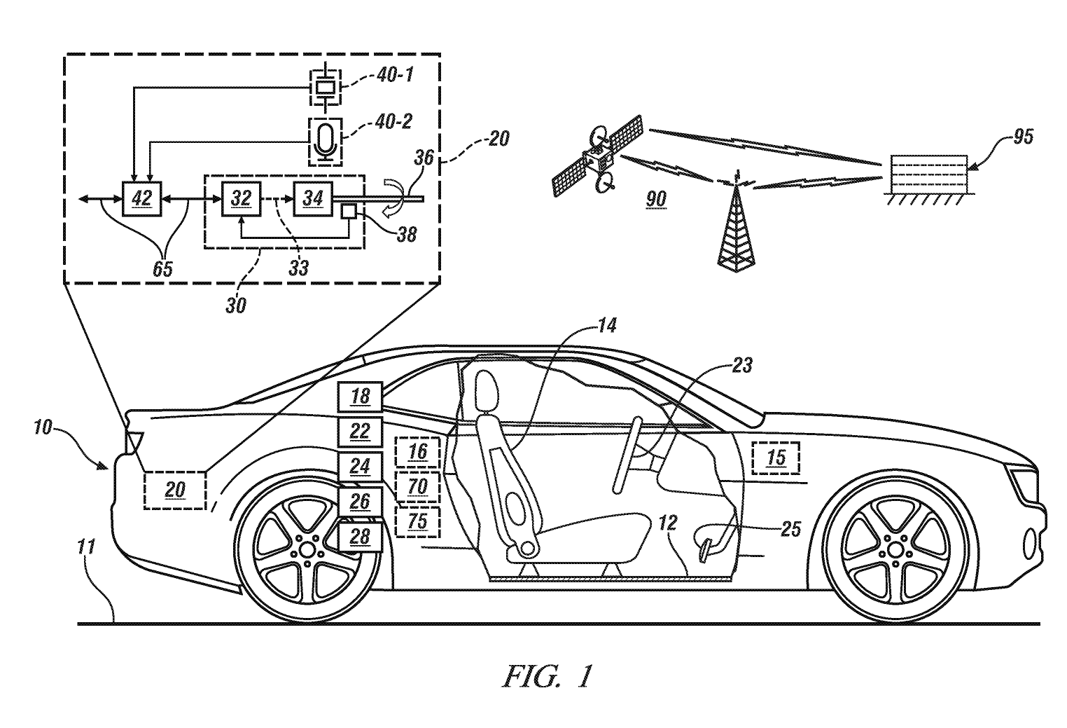

Referring to the drawings, wherein like reference numerals correspond to like or similar components throughout the several Figures, FIG. 1, consistent with embodiments disclosed herein, schematically shows a vehicle 10 disposed on a ground surface 11 and including a plurality of subsystems 30 that are associated with vehicle operation, and a vibration-based monitoring system 20 that includes one or multiple sensors 40 that are disposed on-vehicle to monitor noise and/or vibration, and communicate with a monitoring controller 42. The vehicle 10 is provided to illustrate the concepts described herein. In one embodiment, the vehicle 10 includes an autonomic vehicle control system 15 that is disposed to effect a level of automatic vehicle control. Alternatively, the vehicle 10 may be a non-autonomous vehicle. The vehicle 10 includes a drivetrain 18 that is disposed to generate tractive power for vehicle propulsion. In one embodiment, the drivetrain 18 includes an internal combustion engine and a fixed-gear transmission. Alternatively, the drivetrain 18 may include a fuel/electric hybrid system or an all-electric system that employs an electric motor/generator to provide tractive power. Alternatively, the drivetrain 18 may include another device that provides tractive power. The vehicle 10 is configured, in one embodiment, as a four-wheel passenger vehicle with steerable front wheels and fixed rear wheels. The vehicle 10 may be configured, by way of non-limiting examples, as a passenger vehicle, a light-duty or heavy-duty truck, a utility vehicle, an agricultural vehicle, an industrial/warehouse vehicle, or a recreational off-road vehicle. Other vehicles may include airships and watercraft.

As employed herein, the autonomic vehicle control system 15 includes an on-vehicle control system that is capable of providing a level of driving automation. The terms ‘driver’ and ‘operator’ describe the person responsible for directing operation of the vehicle 10, whether actively involved in controlling one or more vehicle functions or directing autonomous vehicle operation. Driving automation can include a range of dynamic driving and vehicle operation. Driving automation can include some level of automatic control or intervention related to a single vehicle function, such as steering, acceleration, and/or braking, with the driver continuously having overall control of the vehicle. Driving automation can include some level of automatic control or intervention related to simultaneous control of multiple vehicle functions, such as steering, acceleration, and/or braking, with the driver continuously having overall control of the vehicle. Driving automation can include simultaneous automatic control of all vehicle driving functions, including steering, acceleration, and braking, wherein the driver cedes control of the vehicle for a period of time during a trip. Driving automation can include simultaneous automatic control of vehicle driving functions, including steering, acceleration, and braking, wherein the driver cedes control of the vehicle for an entire trip. Driving automation includes hardware and controllers configured to monitor the spatial environment under various driving modes to perform various driving tasks during dynamic operation. Driving automation can include, by way of non-limiting examples, cruise control, adaptive cruise control, lane-change warning, intervention and control, automatic parking, acceleration, braking, and the like.

The autonomic vehicle control system 15 preferably includes one or a plurality of vehicle systems and associated controllers that provide a level of driving automation. The vehicle systems, subsystems and controllers associated with the autonomic vehicle control system 15 are implemented to execute one or a plurality of operations associated with autonomous vehicle functions, including, by way of non-limiting examples, an adaptive cruise control (ACC) operation, lane guidance and lane keeping operation, lane change operation, steering assist operation, object avoidance operation, parking assistance operation, vehicle braking operation, vehicle speed and acceleration operation, vehicle lateral motion operation, e.g., as part of the lane guidance, lane keeping and lane change operations, etc. . . . . The vehicle systems and associated controllers of the autonomic vehicle control system 15 may include, by way of non-limiting examples, drivetrain 18 and drivetrain controller (PCM); a steering system, a braking system and a chassis system, which are controlled by a vehicle controller (VCM); a vehicle spatial monitoring system and spatial monitoring controller, a human-machine interface (HMI) system 16 and associated HMI controller; an HVAC system and associated HVAC controller; operator controls and an associated operator controller; and a vehicle lighting, illumination and external signaling system and associated lighting controller.

Each of the vehicle systems and associated controllers may further include one or more subsystems and an associated controller. The subsystems and controllers are shown as discrete elements for ease of description. The foregoing classification of the subsystems is provided for purposes of describing one embodiment, and is illustrative. Other configurations may be considered within the scope of this disclosure. It should be appreciated that the functions described and performed by the discrete elements may be executed using one or more devices that may include algorithmic code, calibrations, hardware, application-specific integrated circuitry (ASIC), and/or off-board or cloud-based computing systems. Each of the aforementioned controllers can be implemented and executed as algorithmic code, calibrations, hardware, application-specific integrated circuitry (ASIC), or other elements. Data recording can include periodic and/or event-based data recording, single time-point data recording and/or consecutive time-point data recording for certain time duration, such as before and/or after the trigger of an event. Such data recording can be accomplished employing circular memory buffers or another suitable memory device.

The PCM communicates with and is operatively connected to the drivetrain 18, and executes control routines to control operation of an engine and/or other torque machines, a transmission and a driveline, none of which are shown, to transmit tractive torque to the vehicle wheels in response to driver inputs, external conditions, and vehicle operating conditions. The PCM may include a plurality of controller devices operative to control various powertrain actuators, including the engine, transmission, torque machines, wheel motors, and other elements of the drivetrain 18, none of which are shown. By way of a non-limiting example, the drivetrain 18 can include an internal combustion engine and transmission, with an associated engine controller and transmission controller. Furthermore, the internal combustion engine may include a plurality of discrete subsystems with individual controllers, including, e.g., an electronic throttle device and controller, fuel injectors and controller, etc. The drivetrain 18 may also be composed of an electrically-powered motor/generator with an associated power inverter module and inverter controller. The control routines of the PCM may also include an adaptive cruise control system (ACC) that controls vehicle speed, acceleration and braking in response to driver inputs and/or autonomous vehicle control inputs.

The VCM communicates with and is operatively connected to a plurality of vehicle operating systems and executes control routines to control operation thereof. The vehicle operating systems can include braking, stability control, and steering, which can be controlled by actuators associated with the braking system 24, the chassis system 26 and the steering system 22, respectively, which are controlled by the VCM.

The steering system 22 is configured to control vehicle lateral motion. The steering system 22 can include an electrical power steering system (EPS) coupled with an active front steering system to augment or supplant operator input through a steering wheel 23 by controlling steering angle of the steerable wheels of the vehicle 10 during execution of an autonomic maneuver such as a lane change maneuver. An exemplary active front steering system permits primary steering operation by the vehicle driver including augmenting steering wheel angle control to achieve a desired steering angle and/or vehicle yaw angle. Alternatively or in addition, the active front steering system can provide complete autonomous control of the vehicle steering function. It is appreciated that the systems described herein are applicable with modifications to vehicle steering control systems such as electrical power steering, four/rear wheel steering systems, and direct yaw control systems that control traction of each wheel to generate a yaw motion.

The braking system 24 is configured to control vehicle braking, and includes wheel brake devices, e.g., disc-brake elements, calipers, master cylinders, and a braking actuator, e.g., a pedal. Wheel speed sensors monitor individual wheel speeds, and a braking controller that can be mechanized to include anti-lock braking functionality.

The chassis system 26 preferably includes a plurality of on-board sensing systems and devices for monitoring vehicle operation to determine vehicle motion states, and, in one embodiment, a plurality of devices for dynamically controlling a vehicle suspension. The vehicle motion states preferably include, e.g., vehicle speed, steering angle of the steerable front wheels, and yaw rate. The on-board sensing systems and devices include inertial sensors, such as rate gyros and accelerometers. The chassis system 26 estimates the vehicle motion states, such as longitudinal speed, yaw-rate and lateral speed, and estimates lateral offset and heading angle of the vehicle 10. The measured yaw rate is combined with steering angle measurements to estimate the vehicle state of lateral speed. The longitudinal speed may be determined based upon signal inputs from wheel speed sensors arranged to monitor each of the front wheels and rear wheels. Signals associated with the vehicle motion states that can be communicated to and monitored by other vehicle control systems for vehicle control and operation.

The HVAC system 28 is disposed to manage the ambient environment in the passenger compartment, including, e.g., temperature, humidity, air quality and the like, in response to operator commands. The HVAC system 28 includes a pumping device including a rotatable shaft, and may be arranged in a belt-drive system coupled to the engine, or may be arranged in a direct-drive system coupled to an electric motor.

The operator controls can be included in the passenger compartment of the vehicle 10 and may include, by way of non-limiting examples, steering wheel 23, the accelerator pedal and the brake pedal 25 and an operator input device. The operator controls and associated operator controller enable a vehicle operator to interact with and direct operation of the vehicle 10 in functioning to provide passenger transportation. The operator control devices including the steering wheel, accelerator pedal, brake pedal, transmission range selector and the like may be omitted in some embodiments of the vehicle 10 when configured as an autonomous vehicle.

The steering wheel 23 can be mounted on a steering column with an input device configured to communicate with the operator controller. The input device can be located in a position that is convenient to the vehicle operator, and includes an interface device by which the vehicle operator may command vehicle operation in one or more autonomic control modes, e.g., by commanding activation of element(s) of the autonomic vehicle control system 15. The mechanization of the input device is illustrative. The input device may be mechanized in one or more of a plurality of devices, or may be in the form of a controller that is voice-activated, or may be another suitable system.

The HMI system 16 provides for human/machine interaction, for purposes of directing operation of an infotainment system, an on-board GPS tracking device, a navigation system and the like. The HMI system 16 monitors operator requests and provides information to the operator including status of vehicle systems, service and maintenance information. The HMI system 16 communicates with and/or controls operation of a plurality of operator interface devices, wherein the operator interface devices are capable of transmitting a message associated with operation of one of the autonomic vehicle control systems. The HMI system 16 is depicted as a unitary device for ease of description, but may be configured as a plurality of controllers and associated sensing devices in an embodiment of the system described herein. Operator interface devices can include devices that are capable of transmitting a message urging operator action, and can include an electronic visual display module, e.g., a liquid crystal display (LCD) device, a heads-up display (HUD), an audio feedback device, a wearable device and a haptic seat. The operator interface devices that are capable of urging operator action are preferably controlled by or through the HMI system 16. The HUD may project information that is reflected onto an interior side of a windshield of the vehicle, in the field of view of the operator, including transmitting a confidence level associated with operating one of the autonomic vehicle control systems. The HUD may also provide augmented reality information, such as lane location, vehicle path and trajectory, directional and/or navigational information, and the like.

The vehicle 10 includes an ambient condition monitoring system 75 that includes one or more sensors, a controller and a communication routine and is disposed to monitor or otherwise determine proximate ambient conditions. The proximate ambient conditions include, e.g., external temperature, wind speed and direction, precipitation, ambient acoustic noise level, traffic conditions, etc. The ambient condition monitoring system 75 is depicted as a unitary device for ease of description, and may instead be configured as a plurality of devices, controllers and/or communication devices that are arranged to monitor or otherwise determine proximate ambient conditions.

The term “controller” and related terms such as control module, module, control, control unit, processor and similar terms refer to one or various combinations of Application Specific Integrated Circuit(s) (ASIC), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. The term ‘model’ refers to a processor-based or processor-executable code and associated calibration that simulates a physical existence of a device or a physical process. The terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The terms “calibration”, “calibrate”, and related terms refer to a result or a process that compares an actual or standard measurement associated with a device with a perceived or observed measurement or a commanded position. A calibration as described herein can be reduced to a storable parametric table, a plurality of executable equations or another suitable form.

Communication between controllers, and communication between controllers, actuators and/or sensors may be accomplished using a direct wired point-to-point link, a networked communication bus link, a wireless link or another suitable communication link, and is indicated by line 65. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium. A parameter is defined as a measurable quantity that represents a physical property of a device or other element that is discernible using one or more sensors and/or a physical model. A parameter can have a discrete value, e.g., either “1” or “0”, or can be infinitely variable in value.

The terms “prognosis”, “prognostics”, and related terms are associated with data monitoring and algorithms and evaluations that render an advance indication of a likely future event associated with a component, a subsystem, or a system. Prognostics can include classifications that include a first state that indicates that the component, subsystem, or system is operating in accordance with its specification (“Green” or “G”), a second state that indicates deterioration in the operation of the component, subsystem, or system (“Yellow” or “Y”), and a third state that indicates a fault in the operation of the component, subsystem, or system (“Red” or “R”). The terms “diagnostics”, “diagnosis” and related terms are associated with data monitoring and algorithms and evaluations that render an indication of presence or absence of a specific fault with a component, subsystem or system. The term “mitigation” and related terms are associated with operations, actions or control routine that operate to lessen the effect of a fault in a component, subsystem or system.

The telematics controller 70 includes a wireless telematics communication system capable of extra-vehicle communications, including communicating with a communication network system 90 having wireless and wired communication capabilities. The telematics controller 70 is capable of extra-vehicle communications that includes short-range vehicle-to-vehicle (V2V) communication. Alternatively or in addition, the telematics controller 70 has a wireless telematics communication system capable of short-range wireless communication to a handheld device, e.g., a cell phone, a satellite phone or another telephonic device. In one embodiment the handheld device is loaded with a software application that includes a wireless protocol to communicate with the telematics controller. The handheld device is disposed to execute extra-vehicle communication, including communicating with the off-board controller 95 via the communication network 90. Alternatively or in addition, the telematics controller executes extra-vehicle communication directly by communicating with the off-board controller 95 via the communication network 90.

The vibration-based monitoring system 20 for monitoring the subsystems 30 is shown schematically, and includes one or multiple noise/vibration sensors 40 that communicate with the monitoring controller 42. The monitoring controller 42 includes executable algorithms that provide diagnostic and prognostic analytical functions and capabilities.

Two different noise/vibration sensors 40 are shown, including an accelerometer 40-1 and an audio microphone 40-2. The accelerometer 40-1 is a piezoelectric device in one embodiment. Either or both the accelerometer 40-1 and the audio microphone 40-2 can be disposed to monitor vibration on-vehicle. One or multiple accelerometers 40-1 can be mounted in any desired location on-vehicle to sense vibration, including, e.g., a suspension shock tower, a wheel mount, the vehicle floor pan 12, the steering wheel 23, the vehicle seat 14, a vehicle roof support pillar, etc. One or multiple audio microphones 40-2 can be mounted in any desired location on-vehicle to sense audible noise, including, e.g., corner locations in the passenger compartment, underhood, etc. Either or both the accelerometer(s) 40-1 and the microphone(s) 40-2 may be stand-alone devices or may be employed as monitoring devices for one of the subsystems 30 or another subsystem.

Each subsystem 30 includes, in one embodiment, a subsystem controller 32, an actuator 34, a rotatable member 36, and a rotational speed/position sensor 38 that is disposed to monitor rotation of the rotatable member 36 and provide feedback to the subsystem controller 32. The subsystem controller 32 is configured to generate an actuation command 33 that is communicated to the actuator 34. The subsystem controller 32 is disposed to communicate information related to the actuation command 33 and the feedback from the rotational speed/position sensor 38 with the monitoring controller 42 via the communication link 65. An “event” is defined as an occurrence of an actuation command 33 that is communicated to the actuator 34, and can be a command to activate the actuator 34 or a command to deactivate the actuator 34.

The subsystem 30 may include any one of the internal combustion engine, electric motor/generator, the steering system 22, the braking system 24, the chassis system 26, the HVAC system 28, an engine starter, an alternator/generator device, a windshield wiper system, etc.

When the subsystem 30 is the internal combustion engine, the actuator 34 is in the form of a plurality of cylinders attached to a rotatable crankshaft, and the rotating member 36 is the crankshaft.

When the subsystem 30 is the HVAC system 28, the actuator 34 can be in the form of a refrigeration pump and a clutch activated by an electrical relay, and the rotating member 36 is a rotating shaft of the refrigeration pump.

When the subsystem 30 is the steering system 22, the actuator 34 can be in the form of a power steering fluid pump, and the rotating member 36 is a rotating shaft of the power steering pump or, alternatively, an electric power steering motor.

When the subsystem 30 is the braking system 24, the actuator 34 can be in the form of the brake calipers, and the rotating member 36 is the rotating wheel or, alternatively, an electric brake booster motor.

When the subsystem 30 is the engine starter, the actuator 34 can be the electric motor of the starter and the rotating member 36 is a rotatable shaft and associated pinion gear of the electric motor of the starter.

When the subsystem 30 is the alternator/generator device, the actuator can be the motor, and the rotating member 36 is the rotor shaft thereof.

When the subsystem 30 is the electric motor/generator, the actuator can be the electric motor/generator, and the rotating member 36 is the rotor thereof.

When the subsystem 30 is the windshield wiper system, the actuator can be the electric motor, and the rotating member 36 is the rotor thereof.

In each of the aforementioned cases, the subsystem 30 can execute the actuation command 33, which causes the actuator 34 to exert work that operates upon the associated rotatable member 36.

Furthermore, each of the subsystems 30 exhibits, upon occurrence of a fault, a vibration fault signature that may be advantageously described in the frequency domain. The vibration fault signature may be associated with a fault in the actuator 34, a fault associated with the rotatable member 36, and/or a fault associated with an element that is connected to the actuator 34. By way of a non-limiting example, when the subsystem 30 is the windshield wiper system, the actuator can be the electric motor/generator, the rotating member 36 is the rotor thereof, a wiper blade can be coupled to a wiper arm that is coupled to the rotating member 36, with the vibration fault signature being associated with audible noise that is generated by a faulty wiper blade. Other of the subsystems 30 have similar characteristics and vibration fault signatures.

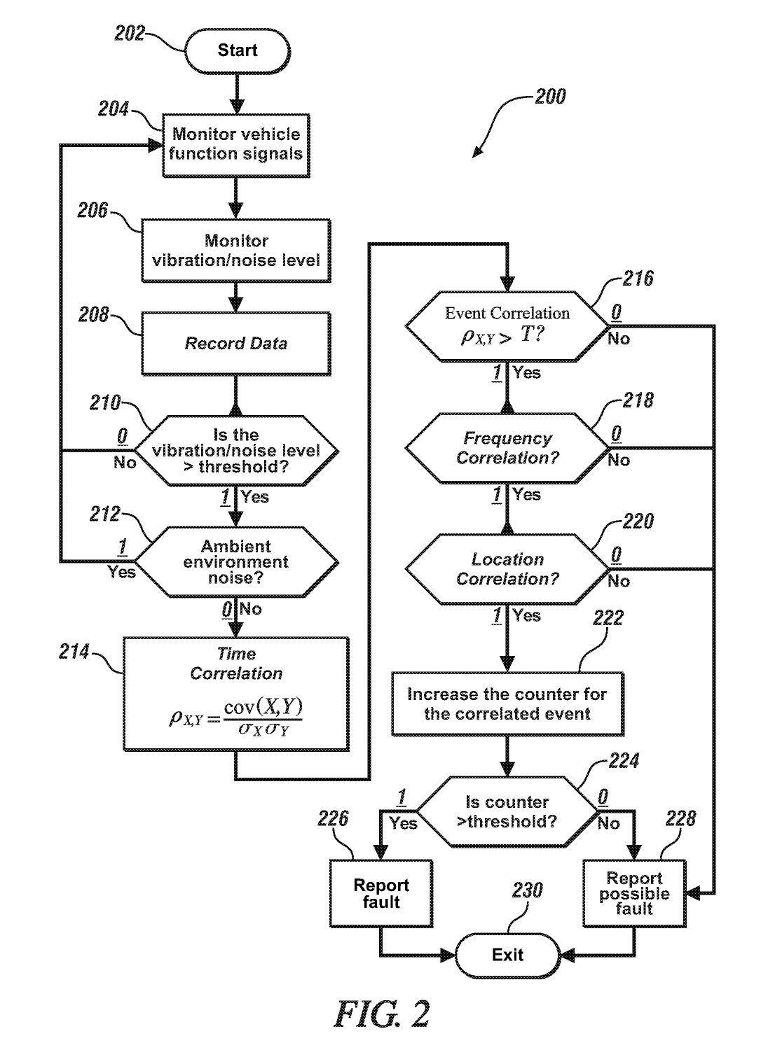

FIG. 2 schematically shows a routine 200 that is executed as part of the vibration-based monitoring system 20, and is associated with operation of an embodiment of the vehicle 10 that is described with reference to FIG. 1, including one or a plurality of subsystems 30, and one or multiple noise/vibration sensors 40 that communicate with the monitoring controller 42. The routine 200 includes a process to detect and isolate a fault associated with one of the aforementioned subsystems 30 that includes determining a correlation between an observed vibration signature and a vibration fault signature for a fault associated with the subsystem. Table 1 is provided as a key wherein the numerically labeled blocks and the corresponding functions are set forth as follows, corresponding to the routine 200. The teachings may be described herein in terms of functional and/or logical block components and/or various processing steps. It should be realized that such block components may be composed of hardware, software, and/or firmware components that have been configured to perform the specified functions.

TABLE 1

| BLOCK | BLOCK CONTENTS |
|---|---|
| 202 | Start |
| 204 | Monitor signals associated with vehicle functions and/or events |
| 206 | Monitor noise/vibration levels |
| 208 | Record data |
| 210 | Is noise/vibration level greater than threshold? |
| 212 | Is noise/vibration due to ambient conditions? |
| 214 | Execute time correlation |
| 216 | Event correlation? |
| 218 | Frequency correlation? |
| 220 | Location correlation? |
| 222 | Increment counter(s) |
| 224 | Is counter(s) greater than threshold? |
| 226 | Report fault |
| 228 | Report possible fault |
| 230 | End iteration |

Execution of the routine 200 may proceed as follows. The steps of the routine 200 may be executed in a suitable order, and are not limited to the order described with reference to FIG. 2. As employed herein, the term “1” indicates an answer in the affirmative, or “YES”, and the term “0” indicates an answer in the negative, or “NO”. The routine 200 starts (202) and preferably regularly executes during each vehicle trip. Execution includes monitoring vehicle function signals that can be associated with an event, i.e., monitoring operator and/or autonomic commands for actuating the subsystem(s) 30 that relate to an event (204). Noise/vibration levels are measured employing the on-vehicle noise/vibration sensors 40. As employed herein, the term “vibration” refers to oscillatory or other repetitive movement of a solid object. As employed herein, the term “noise” refers to mechanical waves passing through a fluid medium such as air and are audible, i.e., within a frequency spectrum that ranges between 20 Hz and 20 kHz. As is appreciated, noise can be caused by vibration of on-vehicle elements or by sources that are external to the vehicle. Proximate ambient conditions are simultaneously monitored employing the ambient condition monitoring system 75. The proximate ambient conditions that may be monitored by the ambient condition monitoring system 75 include external temperature, wind speed and direction, precipitation, ambient noise level, traffic conditions, etc. (206). Associated noise/vibration signals with accompanying time-stamps are recorded and stored in a memory device (208).

The results from the spectral analysis are evaluated to determine whether the magnitude of the noise/vibration level is greater than a threshold within a frequency band. (210). If not (210)(0), the routine returns to step 204 to continue to monitor operator and/or autonomic commands for actuating the subsystem(s) 30 that relate to an event.

If so (210)(1), the magnitude of the noise/vibration level is evaluated to determine if the source of the noise/vibration is outside the vehicle 10, i.e., is due to the proximate ambient conditions (212).

When the source of the noise/vibration is outside the vehicle 10, i.e., is due to the proximate ambient conditions (212)(1), the routine returns to step 204 to continue to monitor operator and/or autonomic commands for actuating the subsystem(s) 30 that relate to an event.

When the source of the noise/vibration is not generated outside the vehicle 10, i.e., is not due to the proximate ambient conditions and is instead likely generated within the vehicle 10 (212)(0), the recorded time-stamps for the vehicle function signals are correlated to the time-stamps for the noise/vibration levels from the on-vehicle noise/vibration sensors 40 employing correlation routines such as a correlation coefficient calculation or a covariance determination routine (214).

Each of the vehicle function signals is evaluated to determine if there is a correlation between one of the events monitored in step 204 and one of the recorded noise/vibration levels from the on-vehicle noise/vibration sensors 40 (216). The types of events are related to individual ones of the vehicle subsystems 30. Furthermore, the types of events can include activating individual ones of the vehicle subsystems 30 and deactivating individual ones of the vehicle subsystems 30.

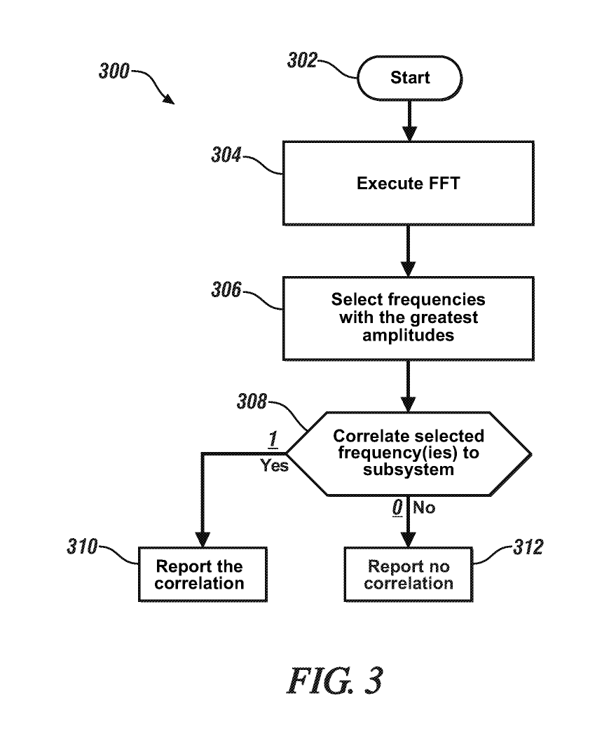

If so (216)(1), the vehicle function signals are evaluated to determine if there is a frequency correlation between vibration associated with operation of one of the vehicle subsystems 30 and one of the recorded noise/vibration levels from the on-vehicle noise/vibration sensors 40 (218). A process for frequency correlation is described with reference to FIG. 3, and includes a process to determine if there is a frequency correlation between vibration caused by a fault associated with one of the vehicle subsystems 30 and one of the recorded noise/vibration levels from the on-vehicle noise/vibration sensors 40. This process to determine the frequency correlation includes determining a subsystem fault frequency, preferably off-line, and comparing the subsystem fault frequency with the recorded noise/vibration levels from the on-vehicle noise/vibration sensors 40.

When there is a frequency correlation (218)(1), the vehicle function signals are evaluated to determine if there is a proximity correlation with one of the recorded noise/vibration levels from one of the on-vehicle noise/vibration sensors 40 in one embodiment (220). In one embodiment, the proximity correlation step may be omitted. When there is no frequency correlation (218)(0), a possible or pending fault can be reported out for the particular vehicle subsystem 30 (228).

If there is a proximity correlation (220)(1), a counter associated with the correlated event is incremented (222). As appreciated, there can be multiple counters, wherein each type of event captured in step 204 can have an associated counter. The types of events are related to individual ones of the vehicle subsystems 30. Furthermore, the types of events can include activating individual ones of the vehicle subsystems 30 and deactivating individual ones of the vehicle subsystems 30, and executing the monitoring and correlation steps with that information. When there is no proximity correlation (220)(0), a possible or pending fault can be reported out for the particular vehicle subsystem 30 (228).

Each counter is compared to an associated threshold (224), and when the counter is greater than the associated threshold (224)(1), a fault can be reported out that is associated with the particular vehicle subsystem 30 (226). When the counter is less than the associated threshold (224)(0), a possible or pending fault can be reported out for the particular vehicle subsystem 30 (228). Either way, the iteration ends (230). Fault reporting and pending fault reporting can include communicating to the vehicle operator via the HMI system 16. Alternatively or in addition, the fault or pending fault reporting can include communicating to the off-board controller 95 via the communication network 90.

FIG. 3 schematically shows a frequency correlation routine 300, which is executed as part of step 218 of the routine 200 that is executed in the vibration-based monitoring system 20, and is associated with operation of an embodiment of the vehicle 10, one or a plurality of the subsystems 30, and one or multiple noise/vibration sensors 40 that communicate with the monitoring controller 42. The frequency correlation routine 300 includes a process to isolate a fault to one of the vehicle subsystems 30 based upon a frequency correlation between a subsystem fault frequency associated with a fault vibration signature from each of the vehicle subsystems 30 and noise/vibration signals that are measured employing the on-vehicle noise/vibration sensors 40. Table 2 is provided as a key wherein the numerically labeled blocks and the corresponding functions are set forth as follows, corresponding to the frequency correlation routine 300. The teachings may be described herein in terms of functional and/or logical block components and/or various processing steps. It should be realized that such block components may be composed of hardware, software, and/or firmware components that have been configured to perform the specified functions.

TABLE 2

| BLOCK | BLOCK CONTENTS |
|---|---|
| 302 | Start |
| 304 | Execute Fast Fourier Transform (FFT) |
| 306 | Select frequency(ies) with the greatest amplitude(s) |
| 308 | Correlate selected frequency(ies) to subsystem(s) |
| 310 | Report correlation |
| 312 | Report no correlation |

The frequency correlation routine 300 executes to determine if there is a frequency correlation between a frequency associated with a fault associated with one of the vehicle subsystems 30 and one of the recorded noise/vibration levels from the on-vehicle noise/vibration sensors 40. Upon starting (302), the noise/vibration data is analyzed, which can include executing a spectral analysis to determine a vibration signature in the form of an amplitude/frequency analysis for the noise/vibration signals from each of the on-vehicle noise/vibration sensors 40 and the signal inputs from the ambient condition monitoring system 75. The spectral analysis may be accomplished via a FFT (Fast Fourier Transform) or other analytical technique. The FFT is executed to analyze the recorded noise/vibration signals from the on-vehicle noise/vibration sensors 40 to extract the frequency spectrum of the noise/vibration signal (304). The resulting frequency(ies) associated with the greatest amplitude(s) from the FFT analysis is selected for comparative evaluation (306). The evaluation includes comparing the resulting frequency(ies) associated with the greatest amplitude(s) from the FFT analysis with a subsystem fault frequency from each of the vehicle subsystems 30, as described with reference to Table 3, as follows. Example subsystems illustrative of the concepts described herein include a braking system, an internal combustion engine, an engine starter, an alternator/generator, a water pump, an electric motor/generator, an HVAC system and a windshield wiper system.

TABLE 3

| Subsystem | Subsystem Fault Frequency |
|---|---|
| Braking system | N * wheel speed |
| Internal combustion engine | N * engine speed * No. of cylinders |
| Engine starter | N * engine speed * gear ratio |
| Alternator/generator | N * engine speed * pulley ratio |
| Water pump | N * water pump speed |
| Electric motor/generator | N * motor speed |
| HVAC system | N * A/C pump speed |
| Windshield wiper system | N * Wiper motor speed |

Each of the vehicle subsystems 30 has an associated fault signature vibration N, which includes one or more frequencies or frequency ranges at which the noise/vibration signal is elevated or at a maximum level when a fault has occurred in the associated vehicle subsystem 30. The subsystem fault frequency at which the noise/vibration signal is elevated can be identified, and is proportional to a rotational speed of the associated rotatable member 36. The subsystem fault frequency for each of the vehicle subsystems 30 is based upon the fault vibration signature N for the vehicle subsystem 30 and the rotational speed of the associated rotatable member 36.

The step of comparing the resulting frequency(ies) associated with the greatest amplitude(s) from the FFT analysis with the frequency range N associated with the fault vibration signature from each of the vehicle subsystems 30 is executed to determine if there is a correlation of the observed frequency with a frequency associated with the fault vibration signature for one of the subsystems 30 (308), and when a correlation is observed (308)(1), it is reported out (310). Likewise, when no correlation is observed (308)(0), it is also reported out (312). In this manner, the routine 300 can determine whether there is a correlation between the observed frequency and a frequency associated with the fault vibration signature for one of the subsystems 30, which permits isolation of a fault.

As such, the concepts described herein may be employed to identify a root cause of a vehicle abnormal noise or vibration using vehicle function signals, and may provide a fast and accurate diagnostic capability for noise or vibration issues. The concepts further provide prognostic capability related to issues in which on-vehicle noise and/or vibration is a precursor. The concepts further include a capability to filter unrelated noise using available environmental information that is perceived, e.g. towing, load, traffic, wind or road conditions. Furthermore, an array of noise and/or noise/vibration sensors can identify the on-vehicle location of the noise/vibration and correlate it with the location information for the vehicle subsystem and related components.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A monitoring system for a vehicle, comprising:
a sensor disposed to monitor on-vehicle noise or vibration;
a subsystem including an actuator, wherein a fault associated with the subsystem is defined by a fault vibration signature; and
a controller in communication with the sensor and the subsystem, the controller including an instruction set, the instruction set executable to:
monitor a command to activate the subsystem;
monitor signal input from the sensor coincident with the command to activate the subsystem,
determine a first vibration signature based upon the signal input from the sensor that is monitored coincident with the command to activate the subsystem,
determine a correlation between the first vibration signature and the fault vibration signature associated with the subsystem, and
determine occurrence of a fault associated with the subsystem when the correlation is greater than a threshold correlation.

2. The monitoring system of claim 1, wherein the actuator includes a rotatable element, and wherein the fault vibration signature associated with the subsystem is determined based upon a rotational speed of the rotatable element of the actuator.

3. The monitoring system of claim 2, wherein the subsystem comprises a wiper system and wherein the rotatable element comprises a shaft of a wiper motor.

4. The monitoring system of claim 2, wherein the subsystem comprises a vehicle braking system and wherein the rotatable element comprises a vehicle wheel.

5. The monitoring system of claim 2, wherein the subsystem comprises an electrical charging system and wherein the rotatable element comprises a shaft of an alternator.

6. The monitoring system of claim 2, wherein the subsystem comprises a starting system and wherein the actuator comprises a shaft of a starter motor.

7. The monitoring system of claim 2, wherein the subsystem comprises a coolant circulation system and wherein the actuator comprises a shaft of a water pump.

8. The monitoring system of claim 2, wherein the subsystem comprises an electric propulsion system and wherein the actuator comprises a shaft of an electric motor/generator.

9. The monitoring system of claim 2, wherein the subsystem comprises an internal combustion engine and wherein the actuator comprises a crankshaft.

10. The monitoring system of claim 1, wherein the sensor disposed to monitor on-vehicle noise or vibration comprises an audio microphone having a detection range associated with an audible spectrum.

11. The monitoring system of claim 1, wherein the sensor disposed to monitor on-vehicle noise or vibration comprises an accelerometer.

12. The monitoring system of claim 1, further comprising a telematics device in communication with the controller and disposed to effect extra-vehicle communication; wherein the instruction set is executable to communicate the fault associated with the subsystem to an off-vehicle controller.

13. The monitoring system of claim 1, further comprising a human-machine interface device in communication with the controller; wherein the instruction set is executable to communicate the fault associated with the subsystem to a vehicle operator via the human-machine interface.

14. The monitoring system of claim 1, wherein the instruction set executable to determine a first vibration signature based upon the signal input from the sensor comprises the instruction set executable to execute a spectrum analysis of the signal input from the sensor to determine the first vibration signature.

15. The monitoring system of claim 1, wherein the instruction set is executable to isolate the occurrence of the fault to the subsystem.

16. A monitoring system for a vehicle, comprising:
a sensor disposed to monitor on-vehicle noise or vibration;
a subsystem including an actuator, wherein a fault associated with the subsystem is defined by a fault vibration signature; and
a controller in communication with the sensor and the subsystem, the controller including an instruction set, the instruction set executable to:
intrusively command activation of the subsystem;
monitor signal input from the sensor coincident with the command to activate the subsystem,
determine a first vibration signature based upon the signal input from the sensor,
determine a correlation between the first vibration signature and the fault vibration signature associated with the subsystem, and
indicate a fault associated with the subsystem when the correlation is greater than a threshold correlation.

17. A method for monitoring an on-vehicle subsystem, comprising:
intrusively activating the subsystem and coincidentally monitoring on-vehicle noise or vibration via a sensor;
determining a first vibration signature based upon the on-vehicle noise or vibration;
determining a correlation between the first vibration signature and a fault vibration signature associated with the subsystem;
detecting, via a controller, a fault associated with the subsystem when the correlation is greater than a threshold correlation; and
communicating the fault to a vehicle operator via an interface device.

18. The method of claim 17, wherein determining the first vibration signature based upon the on-vehicle noise or vibration comprises executing a spectral analysis of the on-vehicle noise or vibration.
